(19) United States
(12) Patent Application Publication
(10) Pub. No.: US 2005/0084348 A1
(43) Pub. Date: Apr. 21, 2005

(54) Drill press/wood lathe two-in-one machine

(76) Inventor: Jiemin Wu, Toronto (CA)

Correspondence Address: JIEMIN WU, 12 Patbrooks Terr, Scarborough, ON, M1P 5G6, CA

(21) Appl. No.: 10/678,915

(22) Filed: Oct. 6, 2003

(51) Int. Cl. B27C 9/00; B27C 5/00; B23G 5/00; B27G 15/00; B23B 51/00; B23D 77/00; B27L 5/02

(52) U.S. Cl. 408/199; 144/1.1; 144/135.2; 144/209.1

(57) ABSTRACT

The present invention relates to a new and improved modification for combining a drill press and a wood lathe into one machine. Further, the present invention relates to an accessory kit, which adds stand-by wood lathe functions to a conventional drill press. The machine is modified from a drill press, which can be set at either vertical position to work as a general-purpose drill press using a drill bit or at horizontal position to work as a wood lathe using a wood chisel for shaping a wood work piece with minimum setup. A support bracket is affixed to the headstock to allow the machine to be laid at horizontal position. A customized drill press base supports another end of the machine and enables the machine to be laid levelly for function as a wood lathe. A driving spur is removably affixed to the spindle to replace the chuck of the drill press for engaging one end of the wood work piece. A tailstock is removably attached to the drill table adapter to replace the drill table for engaging of the opposite end of the work piece. A tool rest is adjustably affixed to a platform clamped on the column of the machine for use with a wood chisel.

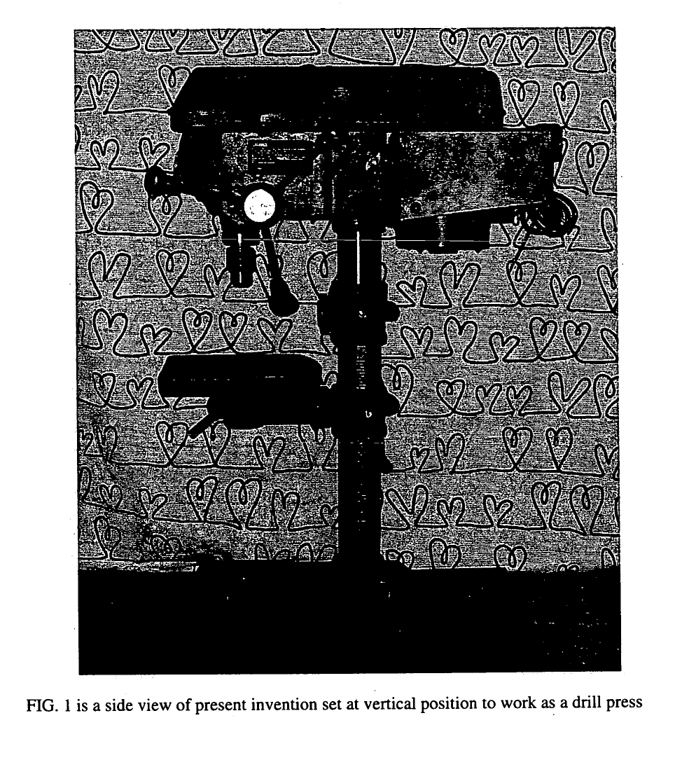

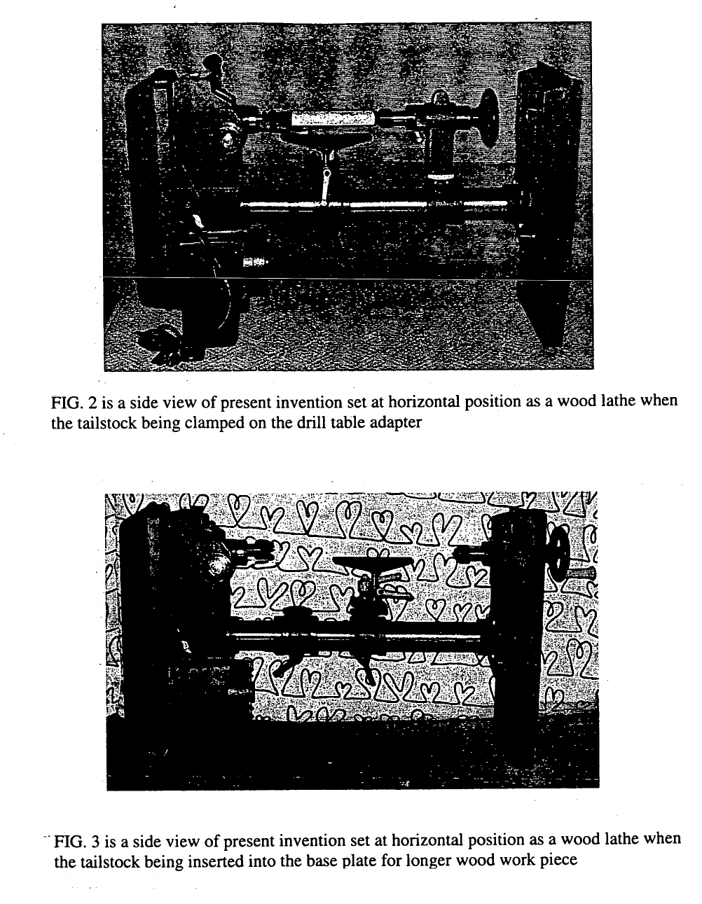

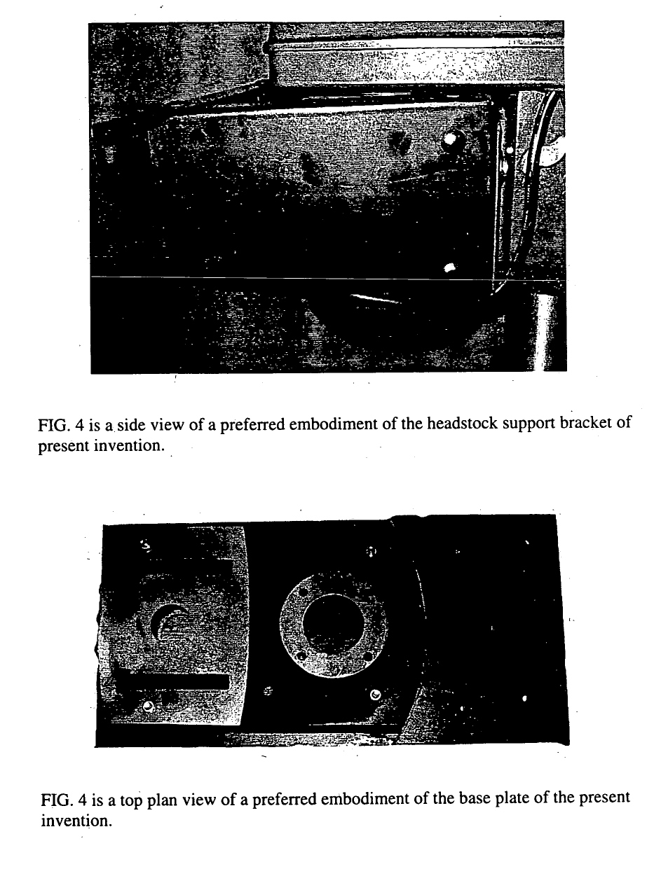

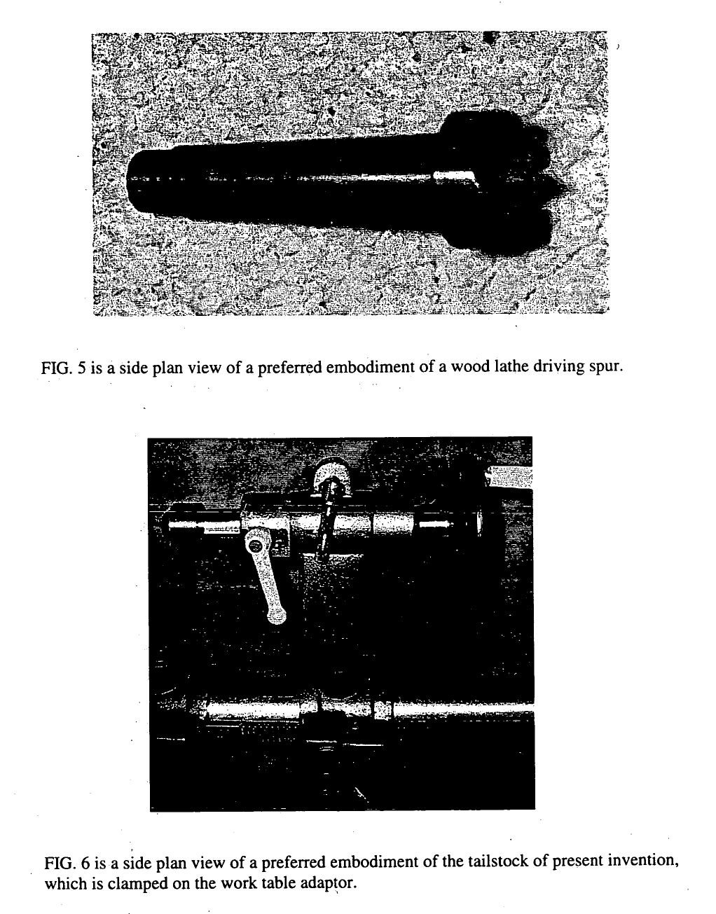

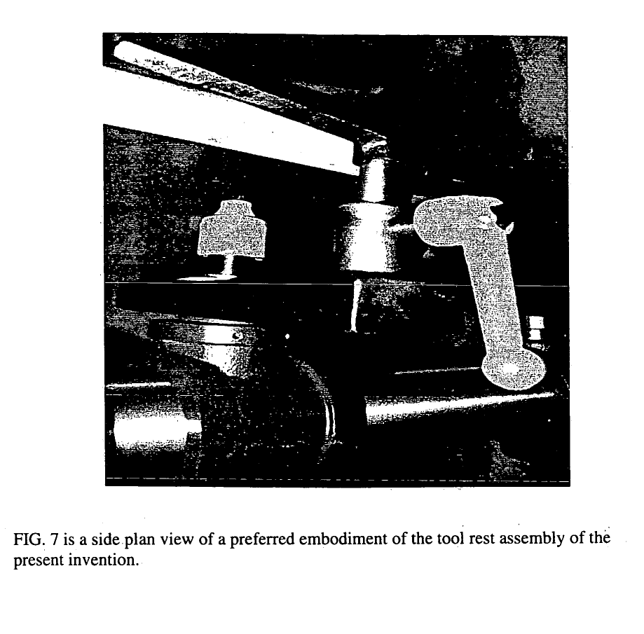

### FIELD OF THE INVENTION

The present invention relates to a new and improved modification for combining a drill press and a wood lathe into one machine. Further, the present invention relates to an accessory kit, which adds stand-by wood lathe functions to a conventional drill press.

### BACKGROUND OF THE INVENTION

General-purpose drill presses are widely used in many home workshops because of its universal usage. A drill press usually consists of a column with a base end and a free end; the base end affixed to a base plate to provide stability to the machine, the free end supports a power head of the machine that includes an electrical motor and a belt-pulley for vary the speed settings. A spindle with a chuck is driven by the power source at a high-velocity rotation. A depth feeding handle or wheel is used to drive the spindle in the direction parallel to the column. A drill table is affixed to the column and can be adjusted to different heights.

A wood lathe is a simple machine in which the primary components includes a frame (can be a column set at horizontal position), a headstock with power source and a high-velocity rotating spindle for driving the first end of the wood work piece, a tailstock for supporting the second end of the work piece, a tool rest adjustably mounted on the frame to support a shaping tool (wood chisel).

It has been recognized that these two machines have many common components such as the power source, the machine frame (column) and the control system can be shared with each other. Thus, the drill press represents not only its own characteristics, but also a possible operational use outside its intended functions. The power head of the drill press can itself be used as a headstock. The column can be used as the machine frame of the wood lathe. The drill table can be confined to use as a tailstock. This potential adaptability, combined with the fact it is typically impractical from an economic perspective for DIY people to purchase a general-purpose drill press and a wood lathe for the purpose of occasional wood carving, has given rise to significant demand for a drill press/wood lathe two-in-one machine combinining the functions of these two machines with minimal assembly and low cost.

A search of the prior art related subject matter uncovered a number of issued U.S. patents. They are:

| | | | |
|---|---|---|---|
| 2089362 | August 1937 | Haas | 144/46. |
| 2200799 | May 1940 | Miller | 144/46. |
| 3709622 | January 1973 | Morse | |
| 3828834 | August 1974 | Morse | |
| 4830069 | May 1989 | Milyard | 144/35. |
| 5562135 | October 1996 | Beth et al. | |
| 5890521 | April 1999 | Dunn | 29/26. |
| 6102089 | August 2000 | McCormick | 144/1.1 |

Some of the previous attempts to adapt the drill press for use as a wood lathe have generally included devices which are costly and overly complex. For example, U.S. Pat. No. 4,830,069 (1989) to Milyard discloses a rather complex Woodworking Machine having a multiplicity of working stations in which different operations can be persormed simultaneously, if so desired. The inventor was trying to make the machine as a complete home workshop including sawing, sanding, cutting, drilling and lathe operations. However, this device (machine) requires significant assembly time, and adjustment (calibration setup) for each of the functions. Therefore, there is a need for a simple combination of two mostly used functions stand-by, has minimal assembly and setting time, and remains low cost.

U.S. Pat No. 5,562,135 (October 1996) to Beth et al discloses a Combination Woodworking Tool manufactured to perform various functions such as drilling and routing. However, machines such as the device disclosed in the reference are still generally complex, set-up time extensively and cost prohibitively for DIY people. Again, there is a need for an assembly that enables a drill press to perform functions of a wood lathe with minimum set-up and low in cost.

U.S. Pat No. 5,890,521 (April 1999) to Dunn discloses a Multi-use Craftsman Table, which are designed for connection of at least one of a plurality of tools for performing a variety of operations on wood work pieces.

U.S. Pat No. 6,102,089 (August 2000) to McCormick discloses a simple adaptation kit for Converting a Drill Press into a Wood Lathe. An adapter plate is affixed to the drill table. Then, a tailstock and a tool rest are all attached to the adapter plate. A driving spur is affixed to the chuck of the drill press. This adaptation kit is designed to fit different drill presses. However, it still needs a user to spend time to install and remove the adaptation kit on a drill press even though these features are quite simple. The rigidity and adjustability of the tool rest affixed on the adaptation plate on the drill table may not meet most DIY users' expectation. Besides, inventor does not provide a method and fixtures to enable the drill press to be laid at horizontal position as for a real wood lathe function.

Citation of these references does not constitute an admission that their disclosures are relevant or material to the presently claimed invention. They are cited only as the closed art of which the inventor is now aware.

1. A drill press modified for combining a conventional drill press and a wood lathe functions into a two-in-one machine. The modified drill press can be set at either vertical position to work as a drill press or at horizontal position to work as a wood lathe. The modified drill press comprising:
A column having a base end and a free end,
A customized base is affixed to the base end of the column for providing stability to the drill press or the wood lathe when being set at vertical or horizontal positions.
A headstock is mounted on the free end of the column;
A support bracket is affixed to the headstock for supporting the headstock end when the machine is set at horizontal position to work as a wood lathe.
The headstock includes the electrical powered motor, a belt-pulley transmission system for various spindle speed settings.
A spindle is affixed to the headstock and driven by the pulley at high turning speeds.
A depth feed handle (wheel) is aligned to the spindle for driving the spindle along the longitudinal axis of the column for drilling to different depths.
A drill table adaptor is clamped on the column, and the adaptor can accept a drill table of the drill press or a tailstock of the wood lathe.

2. The modified drill press of claim 1 wherein the support to headstock is a steel bracket affixed to the motor mounting plate and extended to surround the motor to support the headstock end when the machine is set at horizontal position to work as a wood lathe.

3. The modified drill press of claim 1 wherein the base is customized (enlarged from a conventional drill press) to provide stability to the machine when it is set at either vertical position or horizontal position. Also, the base has a pre-made hole co-centered with the spindle, which enables the tailstock to be mounted on for engaging the second end of a long wood work piece if the total length of the work piece exceeds the tailstock adjusting range.

4. The modified drill press of claim 1 wherein the spindle accepts the Morse sloped shank of a standard chuck for working as a drill press or a Morse sloped shank of a spur for engaging the first end of a wood work piece as a wood lathe.

5. The modified drill press of claim 1 wherein the drill table adaptor has two ends. The mounting end is a box type clamp adjustably affixed to the column. A cranking gear inside the clamp box is engaged with the gear bar attached to the column for adjusting the drill table or tailstock in a direction parallel with the longitudinal axis of the column to accommodate different wood work piece lengths. The free end of the adaptor is a clamp, which accepts the drill table or the tailstock.

6. An accessory kit is used to provide the stand-by wood lathe functions to the machine for shaping wood work piece. The accessory kit comprising:
A driving spur of a wood lathe is removably received by the spindle to replace the drill chuck to engage the first end of a wood work piece.
A tailstock is removeably received by the drill table adaptor to replace the drill table for wood lathe functions.
A tool rest is adjustably mounted on the tool rest platform, which is clamped on the column.

7. The accessory kit of claim 6 wherein the driving spur has a Morse sloped shank, which is received by the spindle of the machine to replace the drill chuck to work as a wood lathe. The spur engages the center of the first end of the work piece to drive the work piece at various turning speeds.

8. The accessory kit of claim 6 wherein the tailstock consists of four components. They are a bushing type housing to fit in the drill table adaptor or the base hole, a tubular shaft that can be adjusted to protrude from inside the bushing housing for fine adjusting the distance between the spur and the tailstock to accommodate the different work piece lengths, an adjust wheel is affixed to one end of the tubular shaft for protrusion adjustment, and a conical point with a Morse sloped shank insertion fits in tubular shaft and its conical end engages the center of the second end of the wood work piece.

9. The accessory kit of claim 7 wherein the tool rest consists of three components. They are a box type clamp, an extension mounting bar and a tool rest bar. The tool rest platform is a box type clamp adjustably affixed to the column. The platform is adjustable in a direction parallel with the longitudinal axis of the column to provide flexibility for the tool rest to be positioned along the column.
The extension mounting bar has a hole on one of the end to accept the tool rest, and the other end is slotted to be adjustably affixed to the box clamp to enable the adjustment of the distance between the too rest and the column. The tool rest supports the shaping chisel for caving the turning work piece and its insertion to the extension bar can be adjusted to different heights. (three-dimensional adjustment)
